(19) United States
(12) Patent Application Publication
(10) Pub. No.: US 2006/0168587 A1
(43) Pub. Date: Jul. 27, 2006

(54) Interoperable communications apparatus and method

(76) Inventor: Shahzad Aslam-Mir, San Diego, CA (US)

Correspondence Address: FISH & RICHARDSON, PC, P.O. BOX 1022, MINNEAPOLIS, MN, 55440-1022, US

(21) Appl. No.: 11/339,240

(22) Filed: Jan. 24, 2006

Related U.S. Application Data
(60) Provisional application No. 60/646,933, filed on Jan. 24, 2005.

(51) Int. Cl. G06F 9/46

(52) U.S. Cl. 718/105

(57) ABSTRACT

A method for dynamically allocating tasks to a plurality of heterogeneous computational processors is provided. The method may comprise populating a time utility function based on a first characteristic associated with quality of service, populating a cost function based on a second characteristic associated with processing consumption, and associating each of the tasks with one of the processors based on at least one of the time utility function and the cost function. An apparatus is also provided that comprises a single instance of a specialized real-time operating system module configured to control a plurality of heterogeneous processors by directly allocating tasks to each of the processors such as to maximize the desired utility function while simultaneously minimizing the associated cost function.

### TECHNICAL FIELD

The subject matter described herein relates to communications. The present application claims benefit under 35 U.S.C. 120 of Provisional Application No. 60/646,933, the contents of which are hereby fully incorporated by reference.

### BACKGROUND

A wide spectrum of communication devices are being developed with ever more complexities and multiple functionalities integrated into a single device. Designing a multipurpose communication device include incorporating multiple processors, each designated to execute specific functions of the device. Likely scenario involves having different engineers design different portions of the device, and thus integration of the different portions represented by function specific processors becomes difficult, time consuming, and extremely costly. For example, it may take 18 months in a wireless products lifecycle to complete integration testing before acceptance testing can be deemed complete. Without an overarching architecture to seamlessly integrate and control all aspects of the device, integration time and cost increases as the complexity of the device increases. Adding to the problem, there may be insufficient interaction between software engineers and radio engineers to efficiently integrate both sides of the design architecture, which may further lengthen the integration process.

For example, a conventional radio communications device may include a general purpose processor, a digital signal processor, and a baseband processor among other processors. Typically, multiple instances of operating software modules are implemented, one for each major processor core, to locally support operation of each processors software modules. For example, a digital signal processor may have an instance of a single OS operating software to control encoding and decoding of radio signal, and the general purpose processor may have another instance of OS operation software module to control execution of application software. This creates duplicity of operating system signal processing software with processors being activated even when not in operation. In addition, delays or latencies are introduced because each processor must wait for the other processor to provide or transmit data to each other. Because operation of each processor is limited by local control mechanism with no regards to other processors, communication among processors are not efficiently handled.

### SUMMARY

In one aspect, tasks are dynamically allocated to a plurality of heterogeneous processors by populating a time utility function based on a first characteristic associated with quality of service. Dynamically allocating tasks may also include populating a cost function based on a second characteristic associated with processing consumption. In addition, each of the tasks many be associated with one of the processors based on at least one of the time utility function and the cost function.

Implementations may include one or more of the following features. For example, a first characteristic associated with quality of service and a second characteristic associated with processing and/or power consumption can be monitored. The second characteristic monitored may be the bit error rate of a signal, and based on the monitored bit error rate, a third characteristic may be adjusted. A plurality of waveforms representing software entities that execute on the processors may also be generated based on a plurality of design parameters. A heartbeat representing a processing speed of executing the waveforms may also be generated.

In some implementations, the associating is repeated for each heartbeat. Optionally, or in addition to, one or both of the monitoring steps are repeated for each heartbeat and/or for a change in power profile. For example, one or both of the monitoring steps may be repeated each time processing consumption exceeds a predetermined threshold. With this configuration, tasks would be reallocated every time an event occurs that causes processing consumption to exceed a certain threshold (based on the time utility function boundaries). The processing consumption level may be based on the amount of processing required for the tasks as a whole across the various processors, or it may be based on a single processor or a subset of processors.

An apparatus may be implemented to include a real-time operating system module configured to control a plurality of heterogeneous processors by directly allocating tasks to each of the processors (as compared to a priority pre-emptive thread-based real-time operating system). This real-time operating system module, may, in some variations, allocate tasks based on a time utility function, where it is maximizing the time utility subject to some cost function for the waveform. The apparatus may also allocate tasks based on a cost function.

The apparatus may also include a virtual operating environment for radio module (VOER). This virtual operating environment for radio module may monitor a first characteristic associated with quality of service and/or a second characteristic associated with processing consumption. If these characteristics are monitored, then the virtual operating environment for radio module may also include a time utility function module, and a power cost function the output of which is used by the real-time operating system module to determine how to directly allocate tasks to the various processors.

The apparatus may also include a waveform design module that adapts waveforms to be compatible for simultaneous usage. With this waveform design module, different waveforms may either be designed so that they are compatible with multiple protocols that would otherwise be conflicting (e.g., Bluetooth and 802.11), or conflicting waveforms may be modified so that they no longer interfere with each other (while preserving substantially all functionality). For example, an OFDM waveform such as 802.11g can be adapted so that it does not have any spectra that conflicts with a frequency hopping waveform such as Bluetooth, through the use of appropriate control (e.g., software defined radio based control of the apparatus).

In yet another variation, an apparatus may be implemented to adapt at least two waveforms for simultaneous usage. The apparatus may also use an operating system to directly allocate tasks to a plurality of heterogeneous processors. The apparatus may also monitor quality of service and processing consumption characteristics. In addition, the apparatus may populate a time utility function and/or a cost function the operating system to determine how to allocate the tasks.

A computer program product may also be provided for dynamically allocating tasks to a plurality of heterogeneous processors, embodied on computer readable-material. The computer program product includes executable instructions that may cause a computer system to conduct any of the method described herein.

A computer system is also described for allocating tasks to a plurality of heterogeneous processors. Such a computer system includes a processor, and a memory coupled to the processor encoding one or more programs that may cause the processor to perform any of the method described herein.

The details of one or more variations of the subject matter described herein are set forth in the accompanying drawings and the description below. Other features, and advantages of the subject matter described herein will be apparent from the description and drawings, and from the claims.

### DESCRIPTION OF DRAWINGS

FIG. 1 illustrates a process flow diagram according to a method variation of the current subject matter described herein;

FIG. 2 illustrates an example of a time utility function and an example of a cost function;

FIG. 3 illustrates an example of major components that may be useful for understanding and implementing the claimed subject matter;

FIG. 4 graphically illustrates the relationship between bit-error-rate and signal-to-noise ratio in a sample device;

FIG. 5 illustrates a process of generating and processing waveforms;

FIG. 6 illustrates a process flow diagram relating to mapping SigTasks into processors.

FIG. 7 illustrates a process of performing adaptive modulation.

Like reference symbols in the various drawings indicate like elements.

### DETAILED DESCRIPTION

The techniques and apparatuses herein are based on the principle of software defined radio (SDR) which allows a wireless device to have programmable waveforms. Waveforms can be provided on a media, and the media holding the waveforms can be loaded onto a generic programmable radio device to allow operability using multiple protocols (e.g., both GSM/GPRS and CDMA). As provided herein, techniques and apparatuses can be implemented to create an operating environment composed of a real time operating system (RTOS) and a runtime element that allows for multiple waveforms to be hosted simultaneously on a device based on certain communications criteria.

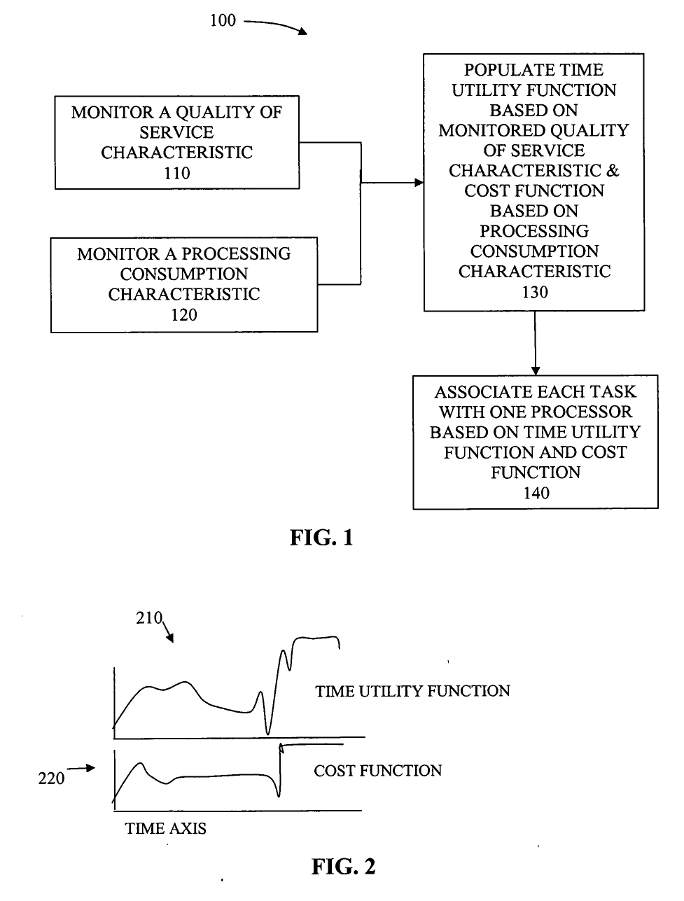

FIG. 1 is a process flow diagram describing a process 100 for dynamically allocating tasks to a plurality of heterogeneous processors. The process can include, at 110, monitoring a first characteristic associated with quality of service at a device. The device can be a hand-held radio device such as a mobile phone, a portable computing device, or other suitable radio wave receiving devices. In some implementations, the monitored first characteristic can be the bit error rate (BER) of a radio signal received by a device. If the device does not have a clear line of sight with the signal transmitter such as a cell tower, the radio signal received by the device can be contaminated by various sources of noise. In addition, at 120, the process can include monitoring a second characteristic associated with processing consumption. In some implementations, the second characteristics can include processing speeds of the plurality of heterogeneous processors. The second characteristic can also include speed of buses or interconnects connecting the plurality of heterogeneous processors. In some implementations, the first and second characteristics can be monitored at the same time. In some implementations, either one of the first and second characteristics can be monitored before the other. The monitored first and second characteristics, are used, at 130, to populate a time utility function and a cost function respectively based on the monitored first and second characteristics. The time utility function can also be used, at 140, to associate each of the tasks with one of the processors. The time utility function is maximized over time and the cost function is minimized over time. The time utility function can be based on factors pertinent to the allocation of tasks to the various processors as well as quality of service issues. For instance, time utility function models as applied to radar and similar applications may be adapted to determine how best to allocate tasks (see, inter alia, Mohammed G. Gouda, Yi-Wu Han, E. Douglas Jensen, Wesley D. Johnson, Richard Y. Kain. Distributed Data Processing Technology, Vol. IV, Applications of DDP Technology to BMD: Architectures and Algorithms, Honeywell Systems and Research Center, Minneapolis, Minn. September 1977. NTIS ADA047475; C. Douglass Locke, Ph.D., Best-Effort Decision Making for Real-Time Scheduling, Thesis, CMUCS-86-134, Department of Computer Science, Carnegie Mellon University, 1986; David P. Maynard, Samuel E. Shipman, Raymond K. Clark, J. Duane Northcutt, Russell B. Kegley, Betsy A. Zimmerman, Peter J. Keleher, An Example Real-Time Command, Control, and Battle Management Application for Alpha Archons Project TR-88121, CMU Computer Science Dept., December 1988; Raymond K. Clark, Scheduling Dependent Real-Time Activities, Ph.D. Thesis, CMUCS-90-155, School of Computer Science, Carnegie Mellon University, 1990 Raymond K. Clark, E. Douglas Jensen and Franklin D. Reynolds, An Architectural Overview of the Alpha Real-Time Distributed Kernel, Proc. of the USENIX Workshop on Microkernels and other Kernel Architectures, pp 200-208, 1993). Further details and optional variations for implementing and understanding this process are provided below.

FIG. 2 illustrates a sample time utility function 210 and a sample cost function 220. The time utility function dimension may be, for example, bit error rate (BER) and the cost function dimension may be, for example, CPU consumption in millions of operations per second (MOP) as consumed by a device to achieve the aforementioned level of BER. A model following least squares algorithm can be implemented to optimize the tracking of the time utility function and its associated cost function. Least squares is a mathematical optimization technique for calculating a best-fit to a set of data by attempting to minimize the sum of the squares of the ordinate differences (called residuals) between the fitted function and the data. The least squares technique requires randomly distributed errors in each measurement. Estimations based on the least squares technique are unbiased and the sample data need not be normally distributed. The model can be implemented in a device to maximize the time utility function and minimizing the cost function in a desired manner to balance the benefits of both sides.

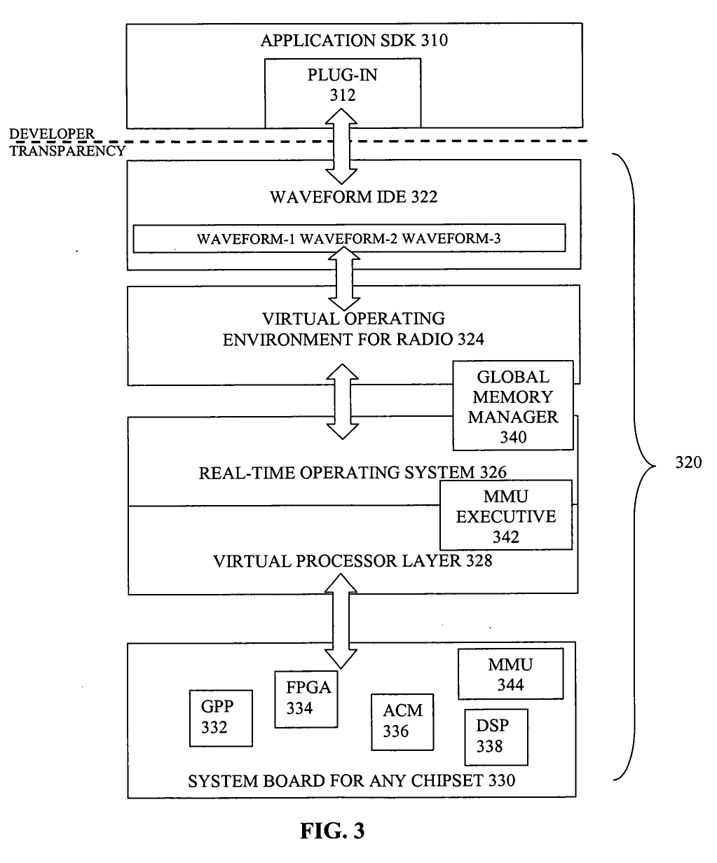

FIG. 3 illustrates some of the major components useful for understanding and implementing the techniques described herein. On the developer side, an application software development kit (SDK) 310 can be implemented to design multiple waveforms to be loaded onto a radio device that share the underlying radio device's provisions and resources in a temporally and specially symbiotic manner. A waveform, in this nomenclature, is defined to be a software entity that uses the underlying hardware resources available in a device to determine if the device is compliant to one or more radio communication standards. The application SDK 310 can be implemented as a plug-in such as one or more of many popular integrated development environments (IDEs) used for building applications such as Code Warrior and J-Builder, and Eclipse. An IDE is a programming environment that has been packaged as an application program, typically consisting of a code editor, a compiler, a debugger, and a graphical user interface (GUI) builder. The IDE can be a standalone application or can be included as part of one or more existing and compatible applications. In some implementations, these IDEs are implemented as plug-ins 312 for connecting into the back of an industry standard IDE such as a Waveform IDE 322. The waveform IDE 322 allows radio engineers to design multiple waveforms and is included in a radio stack 320. The radio stack 320 can include the waveform IDE 322, a virtual operating environment for radio (VOER) 324 communicatively linked to the waveform IDE, a real-time operating system (RTOS) 326 having a lower virtual processor layer 328, and a system board hardware 330.

The VOER 324 assembles the waveforms generated in the waveform IDE 322 or the application SDK 310. The assembled waveforms are loaded onto the system board hardware 330 by the RTOS 326. This single instance of RTOS 326 is capable of implementing the multiple waveforms generated. The system board hardware 330 can include multiple heterogeneous processors such as a general purpose processor (GPP) 332, a field-programmable gate array (FPGA) 334, an adaptive computing machine element (ACM) 336 such as those produced by QuickSilver, and a digital signal processor (DSP) 338. Loading the assembled waveforms onto the processors can include loading specific binary executable modules onto appropriate processors. For example, the binary executable modules related to signal processing can be loaded onto the DSP 338. These components are described in further detail below.

In one aspect of the techniques, a single instance of an RTOS 326 stretching across an entire processor set of a device is implemented. The RTOS 326 focuses on management/handling tasks that are unique to signal processing tasks as compared to a more diverse number of threads. A single instance of RTOS 326 is also capable of operating on and allocating a task across a plurality of heterogeneous processors (e.g., GPP 332, FPGA 334, ACM 336, and DSPs 338). Through the virtual processor layer 328, the RTOS 326 interprets instances of multiple heterogeneous processors present on a system board hardware 330 as one single processor. In addition, the RTOS 326 can extract from the virtual processor layer 328 all signal processing capabilities of the heterogeneous processors. An upper software layer of RTOS 326 can be implemented to consider a signal processing chain, which includes a stream of bytes, and to transform the byte stream as it flows through the heterogeneous processors in a device. Various tasks can be performed to transform the byte stream, and each group of tasks can be optimally performed on a specific processor. For example, coding/decoding functions can be executed on the DSP 338 via the virtual processor layer 328.

In addition, an efficient memory management solution is provided to facilitate loading and execution of binary executable modules in the processors. Instead of requesting memory allocation from the operating system in small quantities at a time as needed, a memory manager is implemented to requests a single larger memory allocation to create a circular ring buffer and implement zero copy semantics for its client applications that demand memory at runtime. A circular ring buffer is an area of memory or a dedicated hardware circuit that is used to store incoming data in a manner that allows the memory buffers to be recycled and reused without incurring any overhead associated with the added demanding for more memory. This is done to create greater determinism and lower operational latency for the software using the memory. When the buffer is filled, new data is written starting at the beginning of the buffer. Circular ring buffers are typically used to hold data written by one process and read by another. In such cases, separate read and write pointers are used that are not allowed to cross each other so that unread data cannot be overwritten by new data. Abstractions of the binary executable modules created in the kernel may need to be transformed. The input buffer holding the incoming executable modules cannot be used to transform the abstractions of the executable modules. A global memory manager 340 can be implemented to manage the flow of data through the circular buffers. Microprocessors are equipped with built-in memory manager units (MMUs) 344, but are usually turned off by the vendors of more traditional real-time operating systems. In addition, the MMU is typically used to create separation kernels for secure or segregated thread and task operation. In this disclosure, the MMU is activated and implemented for a different reason. The MMU can be implemented to optimize the use of shared resources (in this case memory) among multiple waveforms. Since these built in MMUs 344 are extremely efficient, the MMUs 712 are activated, and the virtual processor layer 328 of the RTOS 326 efficiently manages memory using an MMU executive 342 inserted between the MMUs 344 on the processors and the Global Memory Manager 340 to create abstractions.

Waveforms are designed using applicable formulas and some experimentation to ensure proper functionality. For example, Matlab-Simulink™ can be used to generate an algorithm and then the remainder may be designed in an IDE. Data required to compute waveform schema, schedule and manifest can include at least the following input parameters that a radio engineer can utilize to design the waveforms. The parenthetical references relate to functional components of the RTOS:
1. Sampling rate of A/D converter (scheduler)
2. RF to IF conversion details
3. Decimation rate (used to aid the scheduler in calculating the correct rates for other software components to run at so optimally utilize the decimated signal streams)
4. Up conversion rate (scheduler)
5. Down converter rate (scheduler)
6. Modulation scheme [e.g., phase shift keying (PSK), binary phase shift keying (BPSK), quadrature amplitude modulation (QAM), 16 16-QAM, 32 QAM](scheduler)
7. Synchronization details (scheduler)
8. No of target processors in device (heartbeat calculation)
9. Target processor types (heartbeat calculation)
10. Target processor speeds in Mhz. (heartbeat calculation)
11. Data bus speed (scheduler & heartbeat calculation & MIPS budget)
12. Address bus speed (scheduler & heartbeat calculation & MIPS budget)
13. Availability of any intrinsics on processors—e.g. Viterbi on DSP—(scheduler & heartbeat calculation & MIPS budget)
14. Codecs—(scheduler & heartbeat calculation & MIPS budget)
15. FIR/IIR/FFT/IFFT details—(scheduler & heartbeat calculation & MIPS budget)
16. Computed schedule based on the above.

The sampling rate of A/D converter is related to the sensitivity of the device to ensure accuracy of conversion. The radio frequency (RF) to intermediate frequency (IF) conversion details include information related to slowing down the real work and then speeding the real world back up. In some implementations, the signal received is converted from radio frequency into an intermediate frequency and then to a baseband frequency. In some implementations, devices have zero IF, and thus the signal is converted straight to baseband frequency. The decimation rate describes the conversion of analog signals into a set of digital discrete samples of the waveform into in-phase quadrature (IQ) samples. Decimation can reduce the number of samples to a level necessary to maintain the salient germane information in the signal, but still within fewer samples or a coarser sample set. IQ conversion in quadrature and amplitude of a waveform; creates two channels in the device. One channel tracks the amplitude of the wave and the other channel tracks phase of the wave. This is called IQ sampling; The IQ sampling rate and IQ samples can be put into the two channels because information can be coded onto or extracted from the phase or the amplitude in standard frequency modulation (FM) and amplitude modulation (AM) types of waveforms.

Up conversion rate describes frequency conversion from baseband frequency to radio band frequency, and down converter rate describes frequency conversion from radio band frequency to baseband frequency. Modulation scheme describes how information is encoded including the type of modulation used. For example, a modulation scheme may include the process of taking information targeted to put on a radio wave, break up the information and encode it onto some wave, and then give to a radio front end to output into air space or other medium though which radio waves are transmitted. In general, GSM and CDMA modulate information differently, and modulation allows you to encode/decode information onto a carrier and to perform error correction. In addition, modulation affords the ability to discern interfering signal or noise from real data and to encrypt information onto signal and extract it. Types of modulation can include phase shift keying (PSK), binary phase shift keying (BPSK), quadrature amplitude modulation (QAM), and other suitable modulation schemes. Typically, phase-shift keying (PSK) is the modulation technology used in most forms of communications media. PSK covers an umbrella of digital modulation schemes that convey data/voice/information by changing, or modulating the phase of a carrier reference signal in some algorithmic manner to perform self error correction, noise rejection, and other suitable modulations. PSK can also be used to transmit the carrier over some prescribed link that spans some physical channel such as the atmosphere or vacuum as in the case of radio communication. Alternatively, the channel many be a coaxial able or fiber-optic strand as in the case of wired communication.

Synchronization details relate to timing and describe synchronizing a transmitter and a receiver to ensure temporally coherent exchanges of modulated information streams. For example, IEEE 802.11 and Bluetooth both operate in 2.4 Gigahertz, and in order to ensure proper operation, the receiver needs to know when in time to pick up the signal for a frequency hopping signal such as Bluetooth signal and when to look for a frequency domain multiplexed signal such as 802.11 signal in the spectrum. Synchronization details drive receiver sensitivity and control receiver behaviors so as to know when to listen and where to look for the signal in effect. The number of target processors in a device describes the total number of heterogeneous processors in the device. In addition, the target processor types are specified (e.g., GPP, DSP, ACM, etc). Further, processor speeds for various target processors are also specified. The data bus speed and address bus speed also must be specified to allow RTOS to perform heartbeat calculations and generate schedules (which are generated a-priori at design time but implemented/effected at runtime). Processors on the board are connected by the buses, and these physical connections limit the overall processing speed due to intrinsic delays in communicating between processors. For RTOS to perform optimizations, RTOS need to determine what's slow and what's fast. There may be certain intrinsics present in each processors that may increase efficiency. Intrinsics represent well known processing functions built into the hardware because having the executables sitting on the processor is faster loading software into the processor. It is necessary for the RTOS to know the intrinsics to perform optimizations. Codecs describe the encoding/decoding scheme in the DSP. FIR/IIR/FFT/IFFT details determine the accuracy of the signal, and RTOS needs to know the accuracy of the signal to determine what should be filtered before processing, and the degree of fine grained signal shaping and conditioning that needs to take place for the overall BER of the waveform to remain in an optimal section of the specification of the waveforms operational envelope. This avoids unnecessarily processing noise and filtering out good signals. Based on user input parameters 1-15 above, conversion from design time to run time occurs, which includes generating optimal utility functions.

There are a set of intrinsic utility functions that cannot be changed (static) due to hardware limitations of a device. These static utility functions can be combined so that the sum of the static utility functions represent a maximum value at certain point in time. Based on the input parameters (1-15) above, intrinsic time utility functions are identified, and during execution of the waveform(s), the optimal combined time utility function is generated by combining the previously identified individual time utility functions. When a second waveform is loaded onto a device by a deployable bundle, the deployable bundle includes a pre-computed schedule (not computed by device but computed during waveform design that instructs that there will be a second waveform) in order to avoid interfering with the first waveform.

In addition, current generation waveform design requirements may also provide guidance to the waveform design cycle and can include:
a. Channel models to be used (Gaussian, AWGN, Riccian etc)
b. Modulation scheme (BPSK, PSK, n-QAM)
c. Bandwidth in MHz
d. Data Rate
e. Coding rate
f. Spread/Hop feature capability
g. Synchronization requirements and mechanism(s)
h. Security requirement
i. Audio/Video/Data nature of transmission/reception (gives us margin of error tolerable)
j. Is the waveform going to be networked, if so a power efficient form will be generated (e.g. 802.11 is 1.2% power efficient)

Items a-j above are set for a waveform and cannot be altered or configured, Items a-j above characterize the waveform based on the inputs parameters 1-15 above. Items a-j above can also define communication standards such as channel models, spread/hop features, and bandwidth among others. Items a-j may also comprise a manifest and a subsequent item may be calculated as an execution schedule as part of the waveform schema. In addition, items a-j result in executable waveform modules which are clumped together into waveform packages that the VOER 324 will load onto various processor cores at runtime prior to actually starting the waveform.

Waveform archives are generated using a waveform creation tool at the back end when the generated waveforms are deployed. Waveform archives can include a manifest, executable waveform modules, waveform packages, and a schedule. When waveforms are designed, multiple binary executables are also generated. These binary executable modules are loaded onto the heterogeneous processors such as the GPP 332, DSP 338, and FPGA 334. The waveform archive describes how these binary executable modules can be loaded; how the binary executable modules can be connected together in software; and how the software ports can be connected to form continuous waveform servicing signal processing chains (SigChains). The manifest describes the content of the waveform package including the number of binary executable modules and identification of the binary executable modules to be loaded onto each of the heterogeneous processors. In addition, the manifest describes how the binary executable modules can be loaded onto the respective processor, and how the binary executable modules can be connected together across all of the heterogeneous processors to generate and execute signal processor chains to achieve optimization.

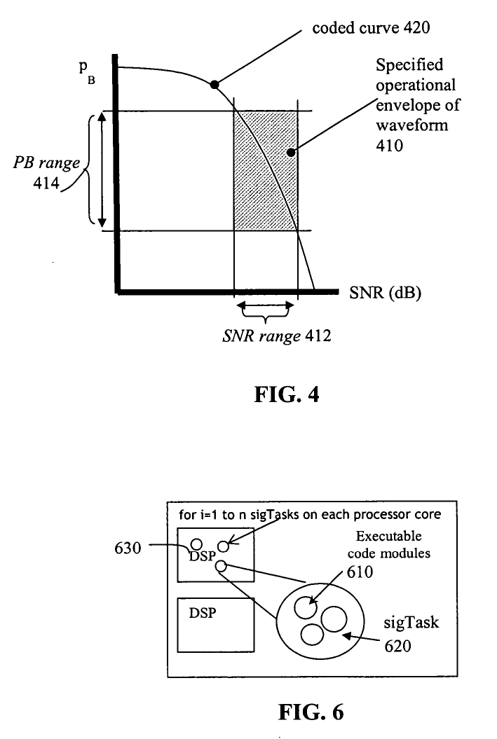

In addition, the current technique may also optimize BER for a given range of signal-to-noise ratio (SNR) in a dynamic manner. Typically, this is referred to as adaptive modulation. However, in the present disclosure, adaptive modulation can be affected by sensing the channel via the BER monitoring and adapting the waveform runtime via the VOER. In addition, the underlying RTOS runtime application structures can be adjusted to improve the results of the modulations. FIG. 4 describes the range of probability of bit and bit rate error (PB) in the communication medium tolerable based on a quality of signal (QoS) desired. PB range is calculated based on the SNR of the communication medium over which a signal is received. The shaded portion 410 represents the specified operational envelop of a given waveform having a corresponding SNR range 412. The communication medium can be a channel including a wire, ether, or any other suitable medium. Ether is the air space over which radio waves travel. SNR for the channel will vary depending on the quality of the channel, and the probability of error can be calculated based on the SNR of the channel. Based on the SNR for the channel, there exists an absolute performance curve 420 beyond which the probability of error will not improve (viz. Shannon's Theorem). Traditionally, devices have been designed with an optimal operating point and built robustly as to generate and maintain a substantially stable probability of error range 414 over a large change in SNR. This robust probability of error range represents static modulation.

In some implementations, an adaptive modulation can be implemented to provide a dynamic probability of error range. Adaptive modulation can be implemented using software radio devices because modulation schemes and parameters can be adaptively changed in software. A process of performing adaptive modulation will be described further with respect to FIG. 8 below.

As an example, a waveform designer's specification sheet for an orthogonal frequency division multiplexing (OFDM) waveform, such as the one provided below, can be used to design a waveform and subsequently generate a waveform archive (WFAR). OFDM is a frequency division multiplexing (FDM) modulation technique for transmitting large amounts of digital data over a radio wave. OFDM works by splitting the radio signal into multiple smaller sub-signals that are then transmitted simultaneously at different frequencies to the receiver. OFDM reduces the amount of crosstalk in signal transmissions. 802.11a WLAN, 802.16 and WiMAX technologies use OFDM.

Example Waveform Specification Sheet
Data rate 6-8 Mbps
Minimum SNR tolerable.
Modulation BPSK, QPSK, 16QAM, 64QAM
Coding: convolution concatenated with Reed Solomon
FFT size: 64 with 52 subcarriers, using 48 for data and 4 pilots
Frequency band 20 Mhz
Subcarrier frequency spacing 20/64=0.3125 Mhz
FFT period: same as symbol period 3.2 microsecs=1/delta_f
Guard duration—¼ symbol, 0.8 microsecs
Symbol time—4 microsecs
Peak to average power-ratio—used to determine waveforms selectively mapped to operational envelope to keep power down and BER within specification.

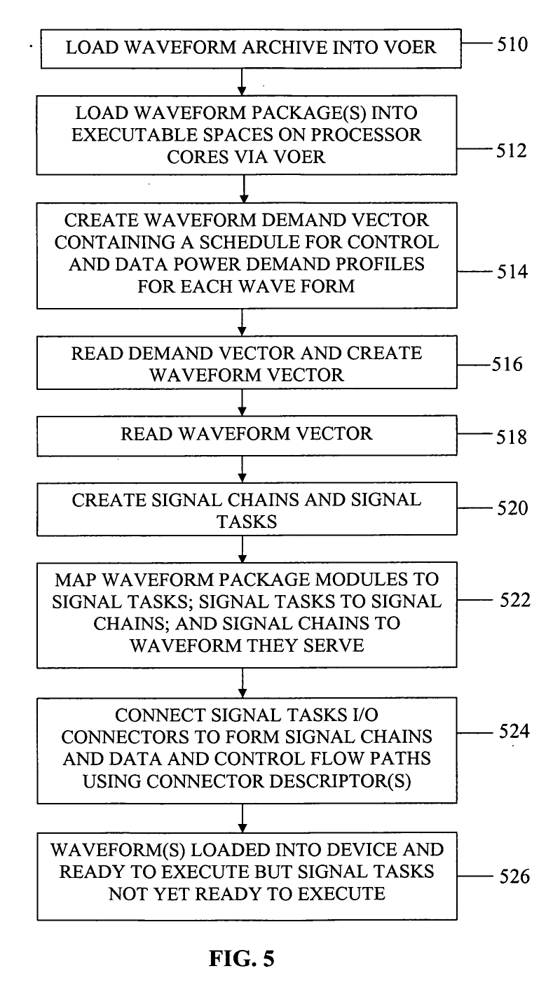

With references to FIG. 5, a modular, highly configurable (and in some implementations self configuring) pluggable micro-kernel architecture may be used for the RTOS 326 into which multiple other devices may be inserted. This arrangement includes a kernel that manages physical and software devices and models physical hardware such as ASIC functionality as specialist devices within the software infrastructure. The kernel manages a group of sigChain managers that create collections or sets of sigchains (chains of signal processing tasks) and through a sigTask manager, manages the creation, activation, shutdown and teardown of the chains and tasks. Once the waveform has been generated, a waveform archive (WFAR) is loaded into a VOER 324 for a waveform at 510, which contains executable packages. The waveform archive can include binary executable modules, a schedule, a waveform package, a manifest, and a connector descriptor. The connector descriptor is a map of software connections describing how the binary executable modules are connected to each other via I/O relationships. At 512, under RTOS 326, a VOER package loader, which is a deployer, reads the waveform archive and opens deployable bundles and loads the binary executable modules into executable spaces on various processors, connects the binary executable modules according to the manifest and calls start on each module. The kernel will read the manifest and make decisions about which signal processing chains can run in user status and which signal processing chains can run in elevated status (super-user), and which signal processing chains can run in the kernel (highest importance/priority). In addition, the kernel performs standard tasks such as loading register and task sets onto processor cores and executing them. Two key components within the kernel include:

1. Criteria executive—this component evaluates how best to load and activate a new waveform based on demand vector and waveform vectors that are created as a result of loading a new WFAR into the VOER 324 and thus into the RTOS 326. These criteria are describe below and may be based, in part, on temporal characteristics and demands that waveform coding, modulation and data rates place on the device; and

2. MMU executive—the memory management unit creates a single memory space for all processor cores to work in and minimizes copies and enforces a near zero copy strategy in all the cores' use of the memory available both on and off processor. The purpose of the MMU executive is to provide an I/O access and read, and minimum instruction fetch mechanism. The MMU executive talks to and supervises the external access to the kernels globally accessible memory manager that gives memory to all applications.

At 514, RTOS 326 creates a waveform demand vector that contains a schedule for control and data power demand profiles for each waveform over time. The demand vector demands from each processor certain processing cycles of time at certain periods in time to allocate a total processing time by combining appropriate contributions from each processor. This demand vector is generated based on the pre-computed schedule contained in the waveform archive. The demand vector describes the optimal combination of processor usage for the execution of the waveform. The waveform demand vector can contain a schedule for control and data power demand profiles of each waveform over time. The demand vector is read by the kernel executive and a waveform vector is created. In addition, a kernel executive reviews all executables on all processors and calculates when the processing cycles demanded by the demand vector can be available from each processor. Thus, the kernel executive determines when each processor is ready to execute the respective binary executable modules loaded onto each processor by the VOER 324. Only one kernel executive is needed for all processors instead of having individual kernel executives for each processor.

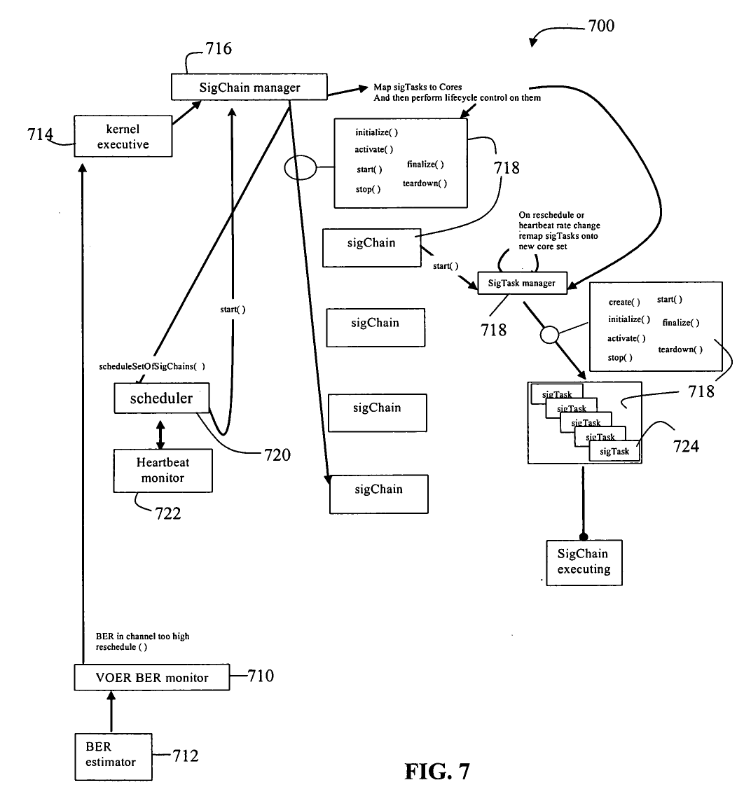

At 516, the RTOS 326 reads the demand vector and determines when the total processing time specified by the demand vector can be initiated to execute the waveform. Thus, a waveform vector is generated and placed on its own executable stack. The waveform vector allocates ahead of time the total processing time specified by the demand vector needed to actually start execution of the waveform. The waveform vector also specifies the actual start time for beginning execution of the binary executable modules. And even though the VOER package loader has already called start on each binary executable modules, the binary executable modules will not be executed until the start time specified by RTOS 326. Some significant asynchronous event handling may take place inside the RTOS 326 kernel as activities start and stop depending upon an admission evaluation and control strategy. These activities can be accepted for starting and running only if the activities can be accommodated within the schedule to ensure that critical deadlines are met to some prescribed degree of acceptable quality of service (QoS). This arrangement allows execution of binary executable modules at appropriate times to avoid delays or latencies. At 518, the binary executable modules connected together by connecting the software connection points together implies a signal processing chain (SigChain). The RTOS 326 can dynamically change the I/O relationships and manage sigChains that contain transformational relationships rather than data flow through relationships. The RTOS 326 runtime is based upon the binary executable modules, from which abstractions are generated in the RTOS 325. The generated abstractions are called the SigChain, which comprises sub-components called a signal processing task (SigTask). The RTOS 326 then links together a series of SigTasks to form a SigChain. At 520, a SigChain manager manages the created SigChain. Managing the SigChain includes mapping binary executable modules to SigTasks via creating an abstraction in the Kernel of the RTOS 326 at 522. The SigTasks are then mapped to SigChains by connecting the SigTasks together by connecting the input/output ports of each SignTasks at 524. Mapping can include specifying which processors will execute which SigTasks of the SigChain (see FIG. 6). Waveforms are now loaded into the device and ready to execute using RTOS 326 SigChain and SigTask mode at 526. Note that the SigTasks are not yet in a ready-executable state and are merely loaded in respective target processor core spaces.

FIG. 6 is a functional diagram describing a process of mapping SigTasks to processors. A SigTask 620 may include multiple executable modules 610 that perform specific functions. The SigTask 620 is loaded into the executable space 630 of an appropriate processor. For example, SigTask 620 may include executable modules 610 related to encoding/decoding signals for error correcting. By efficiently allocating specific tasks to appropriate processor using pre-calculated schedule, power consumption can be reduced and processing delays or priority based inversion blocking avoided. The schedule allows the sigTask to be executed spatially and temporally by pre-allocating time slots ahead of executing the sigTask to ensure that the allocated time is available without delays or conflicts.

In traditional RTOS, general purpose software applications are created without any knowledge of how each processor is being used. In the present disclosure, the exact code to run is controlled in addition to exact execution times for the generated code, and where the code is going to be executed (which processor) ahead of time. This avoids replication of codes and avoids waiting, blocking or any other form of delay in processors to get ready to execute respective binary executable modules (no latency).

Algorithm for VOER/RTOS execution and startup
1. load modules on cores (processor cores)
2. allocate resources per module and memory per module case
3. place modules in ready state
4. extract module schedule of execution from WFAR (waveform archive)
5. execute tasks per core per as stipulated per scheduler instructions (each sigTask is composed of executable code modules.

FIG. 7 is a functional flow chart which describes the process of performing adaptive modulation 700. The VOER 324 can include a BER monitor 710 that estimates the real-time location of the operating point on the performance curve 420. Although the RTOS 326 may be executing all executable modules in optimal manners by utilizing the appropriate processors in an optimal order and at an optimal time for an optimal period of time, there may still be no guarantee that a signal received is a good signal having a low rate of error or noise. For example, a channel of poor quality may produce an error prone signal. The BER monitor 710 checks the BER level and feeds the BER information to the BER estimator 712. The BER estimator 712 can perform calculations to determine if the BER can be improved based on a position on the performance curve 420 and what operational resources are deployed in the RTOS at present. If an improvement can be achieved, the BER estimator 712 calculates needed changes in a SigChain processing to accomplish a shift to an improved position on the performance curve 420, and thus improve the quality of communication. Therefore a feed back mechanism is provided to gather information on the quality of service as defined by channel quality. Based on the calculated information received from the BER estimator 712, the BER monitor 710 communicates with the kernel executive 814 to increase the sensitivity on certain SigTask 824 in the SigChain 718. Then the kernel executive 714 communicates with SigChain manager 716 to makes the needed changes in the SigChain. Changes can include speeding up or slowing down certain binary executable modules; stopping certain modules; and loading new modules and inserting the new modules in the SigChain, or performing other or new additional error correcting activities.

A scheduler 720 is used to schedule sigTasks 724 onto corresponding processor cores and control implied sigChains across those processor cores. The scheduler 720 implements and controls the schedule that the waveform designer generated during the design of the waveform in the waveform IDE or the application SDK when a compiler tools are run over the design and the waveform schema is assembled. The schedule is part of any WFAR. It contains directive to at a minimum, four RTOS components:

1. Synchronization Manager—this element interleaves the sigTasks and respective binary executable modules of multiple disparate waveforms into a single sigChain to be usable by both waveforms. The idea is to do so in a way such as to minimize MOPs consumption and lower power usage, but at the same time provide a static deterministic schedule that makes sure all waveforms get ample CPU core times so as to maintain their performance well within their operational envelopes as determined by the bit-error-rate (BER) vs. signal-to-noise ratio (SNR) coded curve; and

2. Deadlock detector—this component is dynamic and works to detect or predict ahead of time of the possibility of deadlock and livelock and attempts to alleviate, or release resources, slack steal, or reduce the CPU consumption of a waveform that is hindering the device from managing to run any other waveforms at the same time. In essence if a runaway waveform or chain evolves, its effects are minimized. It will try to perform diagnostic and remedial actions if within its range of operations, unless the waveform design is possibly extremely ill-suited to the physical RF device on which it is loaded, in which case the waveform will be etherealized from the schedule of deployed waveform in the RTOS 326.

3. A globally accessible memory manager which gives memory to all applications and entity allocates all memory demands to applications, waveforms, I/O devices, peripheral interfaces, device drivers, DMA buffers, scatter gather algorithms, etc. (suited to protected memory space waveform requirements).

4. A device manager manages the lifecycle control (create, setup, initialize, start, pause, stop, finalize and teardown) of all devices and drivers in the RTOS 326 for all the cores. In addition if there are specific ASICs and ASIPs on the chipset, the device manager subsumes the input/output and control buffers of those chips and makes them appear as devices in the currently described RTOS 326 (which may be chosen for use by a SigChain). The device manger manages kernel and user level devices and also prohibits tampering with kernel level devices unless it is in super-user mode.

The VOER 324 monitors BER for at least the following reason. When a radio is designed, a channel is specified as having certain intrinsic characteristics. These characteristics are defined by a channel model. The channel model can include Gaussian, Riccian, AWGN, or some other suitable channel models. The channel model describes the distribution of the data that makes up the signal and where is the power in the spectrum of the signal. Almost all radio devices are designed with an assumption that the channel model is Gaussian or some derivative thereof, but the channel is not truly Gaussian in most instances. By monitoring the BER, the actual distribution of the data and thus the true characteristic of the channel model can be determined to more accurately identify the channel. If the actual channel model is more similar to Riccian channel, and there is available a library from which a better modulation scheme can be deployed into this channel and improve/lower BER, then the Riccian channel calculation is performed and new modules deployed into the RTOS via VOER for that waveform. The kernel executive is communicated with accordingly to make changes to the SigChain according to the determined channel model. Therefore, truly adaptive top-down modulation change provides a more accurate modeling of the channel than the traditional static modeling provides. By making such tuning adjustments based on the channel, power consumption can be improved by efficiently executing the binary executable modules in the SigChain.

Every SigChain software module has the following six software calls: (1) initialize ( )—bring up the SigTasks and assembles them to form the SigChain; (2) activate ( )—make the SigChain ready to execute but not yet running; (3) start ( )—hard run the SigChain as soon as instructed by RTOS 326; (4) stop ( )—stop execution with extreme prejudice; (5) finalize ( )—start extracting the SigChain from all processors and get ready for teardown by shutting down the executable modules, remove executable codes from the processors, and clean up processor; and (6) teardown ( )—complete shutdown of all executable modules. In this manner, the SigChain 718 can be loaded and unloaded onto the processors easily and in an optimal manner. Each SigChain 718 has a SigTask manager that manages the individual SigTasks. There's also a SigChain manager 716 that manages how multiple SigChains are scheduled and executed without interfering with each other. For example, a first SigChain may share one or more SigTasks with a second SigChain, and the SigChain is responsible to manage the SigTasks in an optimal manner even when certain SigTasks are being shared by the two SigChains.

The heartbeat monitor 722 communicates with the scheduler 720 to control power consumption by adjusting the processing speed as needed. Although executable modules are not actually moving, the SigTasks 724 are perceived to be notionally moving from one processor to another processor (almost synonymous to worker ants) since the code connected to each SigTask 724 is executing on the respective processor. For example, the output of the executable module executing on the DSP 338 may be fed to the input of executable executing on the GPP 332. The heartbeat controls the rate at which SigTasks conceptually move from one processor to another processor, and thus the rate at which the processing moves from one processor to another. This rate of switching from one processor to another depends at least partly on the actual processing speed of the processors. For example, the GPP 332 may be operating at 2 Gigahertz while the DSP 338 is operating at 1.4 Gigahertz.

The heartbeat monitor 722 can also control how long to stay on a particular processor. For example, if the quality of channel improves because the radio device has a clear line of sight with a cell tower, then the BER will improve. With the improved BER, it may even need fewer rake fingers to get good channel, the radio device may not need to perform as much processing on the DSP 338 to correct for error. Therefore, the heartbeat monitor can be implemented to utilize the GPP 332 more than the DSP 338 and thus operate at the speed of the GPP 332. The heartbeat is not related to the speed of the hardware on the board, and thus not restricted to the hardware speed.

Algorithm for Heartbeat Control:

The heartbeat may be the basis for determining whether to reallocate or otherwise modify the allocation of tasks to the various heterogeneous processors. The heartbeat may be a complex valued function which is used both as an RTOS pseudo-clock and clock rate controller as far as the frequency and its rate of change with respect to the placement of tasks on virtual processor executable spaces or actual physical cores is concerned. Heartbeat may be based on numerous factors such as power profile changes, changes in waveform processing demand, and the like. Below is a sample algorithm that may be used for heartbeat control:

```
do
{
  for each 1/k second
      ( this is the heartbeat )
  {
    for each core
    {
      for i=1 to n sigTasks
      {
        for j = 1 to m sigTask modules
        {
          sigTask[.].module[.] -> execute(
          time_slice <from scheduler> )
              (signals the module to go ahead and execute
              on the processor)
        }
        scheduler -> notify( core_id, module_id )
              (signals scheduler that module fired on relevant core)
      }
      scheduler -> notify( sigTask_id )
          (signals scheduler that sigTask was fired on the relevant core)
      scheduler -> schedule( sigTask set )
          (signals scheduler to see if reassessment of schedule
          is needed again)
    }
    if ( ! scheduler -> slack( ) )
    {
      continue
    }
    else( scheduler -> stealslack( ) )
    {
      HeartbeatMonitor->notify( slack )
              (signals change in heartbeat rate)
    }
  }
} while ( operational_state == ( GSM &
BTOOTH & 80211n ) & ACTIVE ) )
    (if one of the waveforms becomes inactive we change heartbeat and
    trigger new schedule)
```

As can be appreciated, the techniques described herein provide many benefits to manufacturers and service providers. They open up the application development environment thereby enabling the development of wireless applications in a write once, run anywhere configuration that increases average revenue per unit. The current techniques also allow for a shorter time-to-market for newer carrier services as mobile communications devices can be quickly adapted to be compatible based on building compatible waveforms. Moreover, the techniques minimize OEM integration costs for new wireless communications devices (using shared RTOS) while minimizing bill of materials costs by reducing hardware requirements (e.g., fewer, and lower cost antennas, and smaller, lower cost and power RF radio front ends) and using commercial off-the-shelf systems, digital signal processors, and general purpose processors.

The techniques described herein also provide benefits to users such as interoperability across increasing disparate communications protocols and the ability to upgrade devices without swapping out core hardware. They also enable the ability to simultaneously run more powerful personal and enterprise applications as an interoperable arrangement based on the creation of hybrid-soft-waveforms would free up application developers for new tasks. Other advantages include enhanced quality of service (i.e., fewer dropped calls or interrupted transmissions) and increased battery life.

The subject matter described herein may be implemented in digital electronic circuitry, or in computer hardware, firmware, software, or in combinations of them. Apparatus of the subject matter described herein may be implemented in a computer program product tangibly embodied in an information carrier, e.g., in a machine-readable storage device or in a propagated signal, for execution by a programmable processor; and methods described herein may be performed by a programmable processor executing a program of instructions to perform functions of the subject matter described herein by operating on input data and generating output. The subject matter described herein may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

A number of embodiments and variations of the subject matter described herein have been described. Nevertheless, it will be understood that various modifications may be made without departing from the scope of the invention. Accordingly, other variations are within the scope of the following claims.

What is claimed is:

1. A method for dynamically allocating tasks to a plurality of heterogeneous processors, the method comprising:
populating a time utility function based on a first characteristic associated with quality of service;
populating a cost function based on a second characteristic associated with processing consumption; and
associating each of the tasks with one of the processors based on at least one of the time utility function and the cost function.

2. A method as in claim 1, further comprising: monitoring a first characteristic associated with quality of service; and monitoring a second characteristic associated with processing consumption.

3. A method as in claim 2, wherein monitoring the second characteristic comprises:
monitoring a bit error rate; and
adjusting at least a third characteristic based on the bit error rate.

4. A method as in claim 1, further comprising generating a plurality of waveforms representing software entities that execute on the processors based on a plurality of design parameters.

5. A method as in claim 1, further comprising generating a heartbeat representing a processing speed of executing the waveforms.

6. A method as in claim 5, wherein the associating is repeated for each heartbeat.

7. A method as in claim 5, wherein the monitoring steps are repeated for each heartbeat.

8. A method as in claim 2, wherein the monitoring steps are repeated for each power profile change or for each change in processing consumption above a predetermined threshold.

9. A method as in claim 1, wherein the associating maximizes the time utility function and minimizes the cost function.

10. A method as in claim 1, wherein the second characteristic is based on an amount of processing required for the tasks on each of the processors.

11. A method as in claim 1, wherein the second characteristic is based on a level of processing associated with at least one of the processors.

12. A method as in claim 1, wherein associating each of the tasks with one of the processors comprises executing the tasks together in a chain by allocating individual processing times from the processors before executing the tasks.

13. A method as in claim 12, wherein allocating individual processing times from the processors before executing the tasks prevents delays between tasks.

14. An apparatus comprising:
a waveform design module configured to generate a plurality of waveforms based on a plurality of design parameters;
a real-time operating system module whose single instance is configured to control a plurality of heterogeneous processors by directly allocating and tracking tasks to each of the processors; and
a virtual operating environment for radio module (VOER) configured to assemble the generated waveforms.

15. An apparatus as in claim 14, wherein said real-time operating system module allocates tasks based on a time utility function and/or a cost function.

16. An apparatus as in claim 14, wherein said virtual operating environment for radio module monitors a first characteristic associated with quality of service and a second characteristic associated with processing consumption.

17. An apparatus as in claim 14, wherein the waveform design module adapts waveforms to be compatible for simultaneous usage.

18. An apparatus as in claim 14, further comprising a monitoring module configured to detect a bit error rate and adjusting allocation of tasks based on the detected bit error rate.

19. An apparatus as in claim 14, further comprising a scheduling module configured to execute tasks together in a chain by allocating individual processing times from the processors before executing the tasks to prevent delays between tasks.

20. A computer program product for dynamically allocating tasks to a plurality of heterogeneous processors, embodied on computer readable-material, that includes executable instructions for causing a computer system to:
populate a time utility function based on a first characteristic associated with quality of service;
populate a cost function based on a second characteristic associated with processing consumption; and
associate each of the tasks with one of the processors based on at least one of the time utility function and the cost function.

21. A computer system for dynamically allocating tasks to a plurality of heterogeneous processors, comprising: a computer system processor; and a memory coupled to said processor, said memory encoding one or more programs causing said processor to:
populate a time utility function based on a first characteristic associated with quality of service;
populate a cost function based on a second characteristic associated with processing consumption; and
associate each of the tasks with one of the processors based on at least one of the time utility function and the cost function.

22. A computer system as in claim 21, wherein associating further comprises executing the tasks together in a chain by allocating individual processing times from the processors before executing the tasks to prevent delays between task.

23. A computer system as in claim 21, wherein the programs further cause the processor to generating a plurality of waveforms representing software entities that execute on the processors based on a plurality of design parameters.
